(19) United States
(12) Patent Application Publication
(10) Pub. No.: US 2014/0279359 A1
(43) Pub. Date: Sep. 18, 2014

(54) Fundamental Investor Natural Demand Matching Engine

(71) Applicant: Andrew MacInnes, Short Hills, NJ (US)

(72) Inventor: Andrew MacInnes, Short Hills, NJ (US)

(21) Appl. No.: 14/205,524

(22) Filed: Mar. 12, 2014

Related U.S. Application Data
(60) Provisional application No. 61/783,502, filed on Mar. 14, 2013.

(51) Int. Cl. G06Q 40/04

(52) U.S. Cl. CPC G06Q 40/04
USPC 705/37

(57) ABSTRACT

An inventive fundamental investor natural demand matching engine is disclosed. An electronic processer linked to a network, receives an indication of interest (IOI) specifying a security, a trade direction and an amount. The system attempts to pair the IOI with any previously received contra-indications of interest (c-IOI), i.e., interest in the same security but in the opposite trading direction. If matched then execute a trade. If the IOI is partially, or not, filled, possible interested counterparties are found using data gathered automatically from public records. The identity and estimated trade size of the potential counterparties are transmitted to the IOI submitting party. If interested in any potential counterparties, the submitting party authorizes sending an anonymous extended indication of interest (e-IOI) to them. If the potential counterparty is interested, a mediated negotiation occurs and if successful, a trade.

### CLAIM OF PRIORITY

This application claims priority from U.S. provisional application 61/783,502 filed on Mar. 14, 2013, the contents of which are hereby incorporated by reference in their entirety.

### FIELD OF THE INVENTION

The invention relates to the electronic trading of securities, and more particularly to a method of electronic agency only trading using a fundamental investor natural demand matching engine.

### BACKGROUND OF THE INVENTION

In the last two decades, advances in information technology have dramatically reduced the cost of trading securities, and the majority of trading now occurs electronically. As a result of these changes, High Frequency Traders (HFTs) have emerged. These are entities that typically use proprietary algorithms to initiate high speed transactions, often based on indications of an intended large buy or sell order. As a result larger, long-term holders of securities now have higher total transactions costs when market impact costs are also included, with HFTs reaping the benefits. In an effort to reduce their vulnerability to HFTs—and, therefore, transactions costs, large investors have actively reduced their average order size to minimize information leakage about their true order size, and have also turned to Dark Pools and Crossing Networks. Dark Pools are designed to provide liquidity and lower transaction costs with guaranteed anonymity. Crossing Networks attempt to match buy and sell orders, executing trades at prices determined in other markets.

However, most Dark Pools allow HFTs to participate in their markets and Crossing Networks rely matching a limited number of buyers and sellers at a given point in time which is not conducive to trading large blocks.

One further factor is the growing popularity of Exchange Traded Funds (ETFs) that has significantly increased the number of passive investors, leaving fewer investors trading on the merits of individual securities.

The result is volatile secondary markets and a decreased ability for companies to raise equity capital. Primary markets worldwide have had a significant decline in the number of, and the amount of proceeds of, public offerings.

### DESCRIPTION OF THE RELATED ART

The relevant prior art includes:

U.S. Pat. No. 5,077,665 issued to Silverman, et al. on Dec. 31, 1991 entitled “Distributed matching system” that describes a matching system for trading instruments in which bids are automatically matched against offers for given trading instruments for automatically providing matching transactions in order to complete trades for the given trading instruments in which controllable subsets of a distributable system trading book may be selectively provided to trading key stations in the matching system from the host computer or central system for dynamically controllably masking the available trading market. The system comprises the host computer for maintaining a host book data base comprising all of the active bids and offers in the system by trading instrument, a transaction originating key station at a client site for providing a bid on a given trading instrument to the system for providing a potential matching transaction, a counterparty key station for providing an offer on the given trading instrument involved in the potential matching transaction, and a network for interconnecting the host computer, the transaction originating key station and the counterparty keys station in the system for enabling data communication there between. Both the transaction originating key station and the counterparty key station each have an associated local data base key station book comprising a subset of the host book. The content of each of the key station books has an associated display depth range which is dynamically controllable by the host computer and is dynamically updatable by transaction update broadcast messages received from the host computer through the network which is preferably transparent to the transactions communicated.

U.S. Pat. No. 8,073,763 issued to Merrin, et al. on Dec. 6, 2011 entitled “Trade execution methods and systems” that describes a system directed to the field of securities trading. One embodiment of the invention relates to securities trading using electronic systems. Another embodiment of the invention relates to a computer implemented trade execution method, comprising: sending from an execution venue to each of a plurality of smart order routers a notification message; receiving at each of the smart order routers the notification message sent thereto, wherein the notification message notifies each of the smart order routers about the presence of a non-displayed priced order at the execution venue; sending from at least one of the smart order routers to the execution venue at least one order to execute against the non-displayed priced order; receiving at the execution venue each order sent from each of the smart order routers; and executing at least one order received from at least one of the smart order routers against the non-displayed priced order.

U.S. Pat. No. 8,027,895 issued to Howorka, et al. on Sep. 27, 2011 entitled “Architecture for anonymous trading system” that describes an anonymous trading system that comprises a network of broker nodes, each of which have an equal status and can match orders, initiate deals and distribute prices. Trading agents are connected to some or all of the broker nodes. The network is arranged to conform to a series of rules and in a preferred embodiment the brokers are arranged as a clique tree.

US Patent Application 20040230512 issued to S. Gulati on Nov. 18, 2004 entitled “Method and system for facilitating opportunistic transactions” that describes an automated internet based exchange system is described for controlling the exchanging of ownership interests in objects on a secondary market. The automated exchange includes one or more sub-exchanges for maintaining information representative of secondary market transactions and for controlling said transactions. The automated exchange includes a secondary portfolio auction sub-exchange, a pricing and valuation services sub-exchange, an electronic contract negotiation services sub-exchange and a delivery and auditing service sub-exchange. The automated exchange also includes a logic switch manager that creates opportunistic auctions from a transaction for a product or service so as to trigger further auctions or service sales on the same or different secondary markets.

Various implements are known in the art, but fail to address all of the problems solved by the invention described herein. Embodiments of this invention are illustrated in the accompanying drawings and will be described in more detail herein below.

### SUMMARY OF THE INVENTION

An inventive fundamental investor natural demand matching engine is disclosed that may be used as a basis for a system and method of electronic agency only trading.

In a preferred embodiment, an electronic processer may be linked to a digital data network. The electronic processer may, for instance, be programmed to perform functions such as, but not limited to, the following.

On receiving an indication of interest, the system may attempt to pair it with any previously received contra-indications of interest. The indication of interest (IOI) may, for instance, specify a security of interest, a trade direction, i.e., whether the party submitting the IOI wants to buy or to sell, and a trade maximum size. The trade maximum size may, for instance, be specified as a number of shares, a monetary figure, or a combination thereof.

If a contra-indication of interest is found to be present, a trade may be negotiated and executed. A contra-indication of interest (c-IOI) may be an IOI in the same security but having an opposite trade direction, i.e., the c-IOI may want to buy and the IOI may want to sell. The trade may be executing at a price set by a pre-agreed reference price such as, but not limited to, the mid-market price of the National Best Bid and Offer.

If there are no c-IOIs to trade, or if such trading has not filled the IOI, i.e., the maximum trade size has not been reached, and if the remaining amount to trade is greater than or equal to the particular trading system's agreed upon minimum trade size, the system may then attempt to identify one or more potential counter parties.

Potential counter parties may, for instance, be identified in real-time from public records or the records may have been accessed previously and potentially relevant information stored on a local memory. The public records may, for instance, be filings such as, but not limited to, the SEC records of publically traded companies. The potential counter parties being sought may differ depending on the direction of and the size of the trade. If the trade is to “Buy”, potential counter-parties may, for instance, be entities such as, but not limited to, owners of significant number of the securities of interest, such individuals, private equity funds or venture capital firms, or companies authorized to sell existing securities or to issue securities. If the trade direction is to “Sell”, then the potential counter-parties may be entities known to have an interest in acquiring significant amounts of that particular security such as, but not limited to, high net-worth individuals, private equity funds, venture capital firms or hedge funds.

Using the publicly available data, the system may also estimate the trade sizes that the potential counter parties may be interested in making.

The potential counterparties and the estimated trade sizes they may be interested in making, may be made available to the party that submitted the IOI.

If the submitting party is interested in querying a potential counterparty, they may instruct the system to anonymously deliver an extended-Indication of Interest. The extended-Indication of Interest (e-IOI) may include data such as, but not limited to, the entity or security of interest, the trade direction, a maximum trade size, a pricing strategy and a trade completion ratio.

The price strategy may, for instance, include items such as, but not limited to, a worst case price, a reference price, and adjustment amount and a time parameter. The reference price may, for instance, be a standard market index such as, but not limited to, a volume weighted average price (VWAP), a closing price, a closing bid, or a mid-market of national best bid or offer (NBBO).

If the selected potential counterparty indicates an interest in negotiating a trade, that negotiation may be done with the system acting as the counter-party to both the buyer and the seller so that the party that submitted the initial IOI may remain anonymous. Once negotiated, the trade may be settled by the system or by a specialist settlement firm.

Therefore, the present invention succeeds in conferring the following, and others not mentioned, desirable and useful benefits and objectives.

It is an object of the present invention to provide a marketplace where larger orders may be made by public fundamental investors.

It is another object of the present invention to integrate secondary and primary markets.

Yet another object of the present invention is to provide a method of executing orders in the style of a Dark Pool, while including insider stakeholders and potentially the entity whose securities are being traded.

Still another object of the present invention is to provide an electronic Alternative Trading System or Multilateral Trading Facility with the benefits detailed above and below.

### BRIEF DESCRIPTION OF THE DRAWINGS

FIG. 1 shows a schematic overview and flow diagram of selected steps of a fundamental investor natural demand matching engine of the present invention.

FIG. 2 shows a schematic view of the elements of an exemplary “indication of interest” of the present invention.

FIG. 3 shows a schematic view of the elements of an exemplary “identified potential counter party” of the present invention.

FIG. 4 shows a schematic view of the elements of an exemplary “extended indication of interest” of the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

FIG. 1 shows a schematic overview and flow diagram of selected steps of a Fundamental Investor Natural Demand Matching Engine (FINDME) 100 of the present invention.

In a preferred embodiment, an electronic processer 105 may linked to a digital data network 115 and programmed to perform the functions of a fundamental investor natural demand matching engine 100.

The electronic processer 105 may, for instance, receive an indication of interest 110, sent via the digital data network 115 from a first party 120.

The indication of interest 110 may, for instance, be an electronic message indicating the desire of the first party 120 to trade a particular type of investment interest, such as, but not limited to, securities issued by a particular company. The indication of interest 110 may also include a trade direction 210, i.e., whether the 1^{st} party wants to buy or sell the securities, and a trade maximum size 215. The trade maximum size 215 may, for instance, be expressed as an amount such as, but not limited to, a number of shares of a security, a monetary value of the securities, a percentage of the particular securities issued or some combination thereof.

The indication of interest may either be a “firm” order representing a binding commitment to buy or sell the securities, or it may not be binding but merely indications from subscribers that they are willing to negotiate. Any such negotiations may, if necessary, be mediated by personal operating the system.

The electronic processer 105 may be programmed to first attempt to pair 125 the indication of interest 110 with a previously received contra-indication of interest 130. The contra-indication of interest 130 may, for instance, be an electronic message from a member 135 of the alternative trading system that is prequalified to trade on the system that has indicated an interest in trading the same particular securities that the first party 120 is interested in trading, but in the opposite trading direction. A contra-indication of interest 130 may, for instance, be interested in buying if the indication of interest 110 is in selling, and vice versa. The contra-indication of interest 130 may also include a trade maximum size 215, that may also be expressed as an amount such as, but not limited to, a number of shares of a security, a monetary value of the securities, a percentage of the particular securities issued or some combination thereof.

If a matching pair is found, a trade 140 may either be executed according to the terms of the indications of interest 110 or a trade 140 may be negotiated and executed. The trade 140 may, for instance, be executing at a price determined relative to a pre-agreed or negotiated reference price such as, but not limited to, the mid-market price of the National Best Bid and Offer.

Any particular trade may not exhaust the first party's 120 total requirements, i.e., their maximum trade maximum size 215. If the remaining, or residual, amount of securities still exceeds any minimum trade size requirements of the system, the system may continue to search for possible pairings until the contra-indications of interest are exhausted 145 and no further pairing is made.

The system may then switch to identifying potential counter parties 150.

The counter parties 150 may be found automatically from publically available documents accessible online such as, but not limited to, SEC filings, or from subscription business sites such as, but not limited to, Hoovers, or some combination thereof. In a preferred embodiment, this type of information may have been pre-assembled into a proprietary database that may, for instance, be updated on a daily or real time basis. The information gathered may include due consideration for various legal and regulatory requirements and constraints associated with any potential trading.

The identified possible counter parties 150 may be of a similar type to subscribers to the system, i.e., they may be entities such as, but not limited to, public institutional investors, the company who securities are being traded, executive officers or directors of the company who securities are being traded, employees or other groups of individual investors affiliated with the company who securities are being traded, private institutional investors such as, but not limited to, venture capital or private equity firms, high net worth private individuals or some combination thereof.

The next step in the process may be presenting 155 the first party with one or more identified potential counter parties 150 and an estimated trade size of interest 220 of each of the potential counter parties.

The first party 120 may then select one or more of the potential counterparties 160 and send an authorization to the system to proceed with the selected potential counterparties.

The system may then automatically inform 165 the selected counterparties. This may take the form of automatically sending them an electronic message that is an extended indication of interest 270. The extended indication of interest 270 sent to the potential counterparties 170 may, for instance, include the type securities involved including the entity of interest 205, the trade direction 210, the trade maximum size 215, a closing price 255 and a trade completion ratio 230 of the 1^{st} party.

If a potential counterparty 170 indicates an interest 185, the system may then proceed to negotiating a trade 175. Negotiating a trade 175 may, for instance, be mediated by the personnel operating the fundamental investor natural demand matching engine 100, or the parties may select a mutually agreeable third party mediator, or they may elect to forego unanimity and negotiate between themselves.

Once a trade is negotiated, the trade may be settled 180, either by the system or by a designated trading firm.

The system may then reach the end of processing current indication of interest 190.

FIG. 2 shows a schematic view of the elements of an exemplary “Indication of Interest” 110 of the present invention. The indication of interest 110 may, for instance, include elements such as, but not limited to, an entity of interest 205, a trade direction 210 and a trade maximum size 215. The indication of interest 110 may also optionally include a minimum trade size, though a fundamental investor natural demand matching engine 100 may typically have its own, pre-agreed, minimum trade size.

The indications of interest 110 may be submitted by a member who may be pre-qualified to trade on the particular implementation of the fundamental investor natural demand matching engine 100. The indication of interest 110 may be non-binding and may require additional action by the party submitting them before they can be executed as orders.

The entity of interest 205 may, for instance, be securities in a particular company.

The trade direction 210 may, for instance, be whether the submitting party is interested in selling or buying the securities of interest.

The trade maximum size 215 may, for instance, be an indication of the maximum amount of the entity of interest 205 the submitting party is interested in trading. The maximum amount may be expressed by a suitable number such as, but not limited to, the number of securities, the monetary value or “dollar amount” of the shares or the percentage of issued securities of the entity of interest that are available to be traded or some combination thereof.

FIG. 3 shows a schematic view of the elements of an exemplary “identified potential counter party” of the present invention.

The identified counter party shown may be the information automatically sent as an electronic message to the party that submitted the indication of interest 110. Both the identity of the potential counterparty and the estimated trade size of interest 220 may be gained automatically from publically available date, or data made available by a third party aggregator of such data, or a combination thereof. This data may, for instance, be obtained by proprietary software modules or “bots” scouring the internet for relevant data.

FIG. 4 shows a schematic view of the elements of an exemplary “extended indication of interest” of the present invention. The extended indication of interest 270 may, for instance, include items such as, but not limited to, the entity of interest 205, the trade direction 210, the trade maximum size 215, a price strategy 225 and a trade completion ratio 230.

The extended indications of interest 270, also referred to as residual orders, may or may not be legally binding offers, but are expected to be treated as firm orders that will be honored. The extended indication of interest 270 is therefore intended to be good until cancelled or the indicated expiration time is reached.

Most of these items in the extended indication of interest 270 are described in detail above.

The trade completion ratio 230 is a numerical indication of the submitting parties past performance on the particular fundamental investor natural demand matching engine 100. The trade completion ratio 230 may be an indication of how many of the party's “indications of interest” have resulted in completed trades or reached their expiration time and may, therefore, be indicative of the seriousness of their interest.

The price strategy 225 may contain a number of elements such as, but not limited to, a worst-case price 235, a reference price 240, an adjustment amount 275 and a time parameter 245.

The worst-case price 235 is the least favorable price the submitting party may be willing to accept.

The reference price 240 may be a price determined independently on another markets or exchanges such as the primary exchange on which the securities of interest are traded and may be selected from values such as, but not limited to, a volume weighted average price (VWAP) 250, a closing price 255, a closing bid 260, a mid-market price of a displayed national best bid or offer (NBBO) 265, a specific price 266, or some combination thereof.

The adjustment amount 275 may be the amount to be added to or subtracted from the reference price 240 to determine the trade price.

The time parameter 245 may, for instance, be an indication of the expiration time of the extended indication of interest 270 and be a number such as, but not limited to, 0 to indicate a same day trade expiration, +1, +2 and so on, each indicating the number of days the trade is open. The time of expiration on the particular day may be pre-agreed and may, for instance, be a number of hours after a primary exchange has closed, such as, but not limited to, 2 hours after trading on the primary exchange for the particular security closes.

If the selected potential counterparty is a member of the particular implementation of the fundamental investor natural demand matching engine 100, the extended indication of interest 270 may be sent as an electronic notification. If they are not, other methods may be required to ensure rapid notification such as, but not limited to, email, telephone call, messenger delivery or some combination thereof.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A fundamental investor natural demand matching engine of the present invention, comprising:
an electronic processer linked to a digital data network, said electronic processer being programmed to perform functions comprising:
receiving an indication of interest from a first party, said indication of interest comprising a trade direction and a trade maximum size;
attempting to pair said indication of interest with a previously received contra-indication of interest, and if one or more contra-indications of interest are present, executing a trade between a portion of said indication of interest and said contra-indication of interest at a negotiated price or at a price determined by a reference price;
if after attempting to pair said indication of interest with counter indications of interest, said trade maximum size of said indication of interest has not been reached, presenting said first party with one or more identified potential counter parties and an estimated trade size of interest of each of said potential counter parties, said identified potential counter parties and said estimated size of interest having been automatically identified and calculated from publicly available records;
if authorization is received from said first party to proceed with one or more selected potential counterparties, automatically informing said selected potential counterparties of using an extended indication of interest; and
if said selected potential counterparty indicates an interest, executing a trade and settling said trade.

2. The method of claim 1 further comprising:
providing one or more members prequalified to trade with an implementation of said method of trading; and
if said selected potential counterparties is one of said members of generating and delivering notifications to said authorized identified potential counter parties.

3. The method of claim 1 wherein said selected potential counterparties are further informed of a specific price strategy and a trade completion ratio of said first party and that said indication of interest is good until cancelled.

4. The method of claim 3 wherein said price strategy comprises a worst-case price, a reference price and an adjustment amount, and a time parameter.

5. The method of claim 4 wherein said specific price strategy is selected from the group consisting of a volume weighted average price (VWAP), a closing price, a closing bid, a mid-market of national best bid or offer (NBBO), a specific price and a combination thereof.

6. The method of claim 2 wherein said presenting said first party with one or more identified potential counter parties only occurs if a remaining size of said indication of interest exceeds remaining trade size is in excess of a minimum trade size agreed as part of becoming one of said members.

7. The method of claim 4 further including an adjustment amount to be added or subtracted from said selected pricing strategy.

8. The method of claim 6 further including a worst case price being either the maximum purchase price or the minimum sale price said first party is willing to accept should the selected price strategy result in a less favorable price.

9. The method of claim 2 wherein an entity controlling said implementation of said method of trading acts as counter-party to both the first party and said selected counterparty in the event of a trade being consummated.

10. The method of claim 1 wherein said reference price is the mid-market of the National Best Bid and Offer.
